(19) United States
(12) Patent Application Publication
(10) Pub. No.: US 2025/0136851 A1
(43) Pub. Date: May 1, 2025

(54) ADHESIVE COMPOSITE MATERIAL AND METHODS OF FORMING THE SAME

(71) Applicant: SAINT-GOBAIN PERFORMANCE PLASTICS CORPORATION, Solon, OH (US)

(72) Inventors: Christoph SCHUBECK, Reichersbeuern (DE); Edgar Lindner, Lenggries (DE); Jan Scheffel, Bad Tölz (DE); Andreas Roth-Rosenkranz, München (DE)

(21) Appl. No.: 18/908,906

(22) Filed: Oct. 8, 2024

Related U.S. Application Data
(60) Provisional application No. 63/589,471, filed on Oct. 11, 2023.

(51) Int. Cl. C09J 9/00; C09J 7/38; C09J 133/04

(52) U.S. Cl. CPC C09J 9/00; C09J 7/385; C09J 133/04; C09J 2301/12; C09J 2301/20; C09J 2301/202; C09J 2301/302; C09J 2400/14; C09J 2400/22; C09J 2400/283; C09J 2423/006; C09J 2433/00; C09J 2467/006

(57) ABSTRACT

A pressure sensitive adhesive composite material may include a pressure sensitive adhesive layer that may include a pressure sensitive adhesive material, and a scrim layer that may include a grid of fibers. The scrim layer may be encased within the pressure sensitive adhesive layer. The pressure sensitive adhesive composite material may include a grid region of the fibers coated with the pressure sensitive adhesive material, and a plurality of window regions of the pressure sensitive adhesive material between the fibers. An average thickness of the plurality of widow regions is less than an average thickness of the grid region.

### CROSS-REFERENCE TO RELATED APPLICATION(S)

This Application claims priority under 35 U.S.C. § 119(e) to U.S. Provisional Patent Application No. 63/589,471, entitled “ADHESIVE COMPOSITE MATERIAL AND METHODS OF FORMING THE SAME,” by Christoph SCHUBECK et al., filed Oct. 11, 2023, which is assigned to the current assignee hereof and is incorporated herein by reference in its entirety.

### FIELD OF THE DISCLOSURE

The present disclosure relates to an adhesive composite material and methods of forming the same. The present disclosure further relates to a tape that includes an adhesive composite material and methods of forming the same.

### BACKGROUND

Pressure sensitive adhesives and pressure sensitive adhesive composite materials are used to attach a variety of substrates in a number of industrial and consumer markets. Depending on specific applications, pressure sensitive adhesives or pressure sensitive adhesive composite materials may be designed either as one single layer or as multiple layers. In certain industries and applications, such as, building applications, vapor permeability of the adhesive in combination with water and air resistance of the adhesive must be balanced to improve performance. In particular, pressure sensitive adhesives used in building applications may contribute to controlling humidity in the building, roof, or wall, which is essential for maintaining longevity of the building products and preventing damage that can be caused by water or vapor diffusion through the adhesive. Therefore, there is a strong need to develop pressure sensitive adhesive composite materials that retain high overall performance by balancing vapor diffusion and vapor permeability.

### SUMMARY

According to a first aspect, a pressure sensitive adhesive composite material may include a pressure sensitive adhesive layer that may include a pressure sensitive adhesive material, and a scrim layer that may include a grid of fibers. The scrim layer may be encased within the pressure sensitive adhesive layer. The pressure sensitive adhesive composite material may include a grid region of the fibers coated with the pressure sensitive adhesive material, and a plurality of window regions of the pressure sensitive adhesive material between the fibers. An average thickness of the plurality of widow regions is less than an average thickness of the grid region.

According to yet another aspect, a pressure sensitive adhesive composite material may include a pressure sensitive adhesive layer that may include a pressure sensitive adhesive material, and a scrim layer that may include a grid of fibers. The scrim layer may be encased within the pressure sensitive adhesive layer. The pressure sensitive adhesive composite material may include a grid region of the fibers coated with the pressure sensitive adhesive material, and a plurality of window regions of the pressure sensitive adhesive material between the fibers. The pressure sensitive adhesive composite material may have a surface roughness of at least about 5 microns.

According to still another aspect, a pressure sensitive adhesive composite material may include a pressure sensitive adhesive layer that may include a pressure sensitive adhesive material, and a scrim layer that may include a grid of fibers. The scrim layer may be encased within the pressure sensitive adhesive layer. The pressure sensitive adhesive composite material may include a grid region of the fibers coated with the pressure sensitive adhesive material, and a plurality of window regions of the pressure sensitive adhesive material between the fibers. The pressure sensitive adhesive composite material may have an apparent density of not greater than about 1 g/cm³.

According to yet another aspect, a method of forming a pressure sensitive adhesive composite material may include providing a pressure sensitive adhesive precursor material between a first production film and a second production film, inserting a scrim layer into the pressure sensitive adhesive precursor material between the first production film and the second production film to form a preliminary pressure sensitive adhesive composite material between the first production film and the second production film, compressing the preliminary pressure sensitive adhesive composite material between the first production film and the second production film, and curing the compressed preliminary pressure sensitive adhesive composite material to form the pressure sensitive adhesive composite material. The pressure sensitive adhesive composite material may include a pressure sensitive adhesive layer that may include the pressure sensitive adhesive material. The scrim layer may include a grid of fibers. The scrim layer may be encased within the pressure sensitive adhesive layer.

### BRIEF DESCRIPTION OF THE DRAWINGS

Embodiments are illustrated by way of example and are not limited to the accompanying figures.

FIG. 1 includes a diagram showing a pressure sensitive adhesive composite forming method according to embodiments described herein;

FIG. 2a includes an illustration showing side view of a configuration of a pressure sensitive adhesive composite formed according to embodiments described herein; and

FIG. 2b includes an illustration showing top view of a configuration of a pressure sensitive adhesive composite formed according to embodiments described herein.

Skilled artisans appreciate that elements in the figures are illustrated for simplicity and clarity and have not necessarily been drawn to scale.

### DETAILED DESCRIPTION

The following discussion will focus on specific implementations and embodiments of the teachings. The detailed description is provided to assist in describing certain embodiments and should not be interpreted as a limitation on the scope or applicability of the disclosure or teachings. It will be appreciated that other embodiments can be used based on the disclosure and teachings as provided herein.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Embodiments described herein are generally directed to a pressure sensitive adhesive composite material and methods of forming the same.

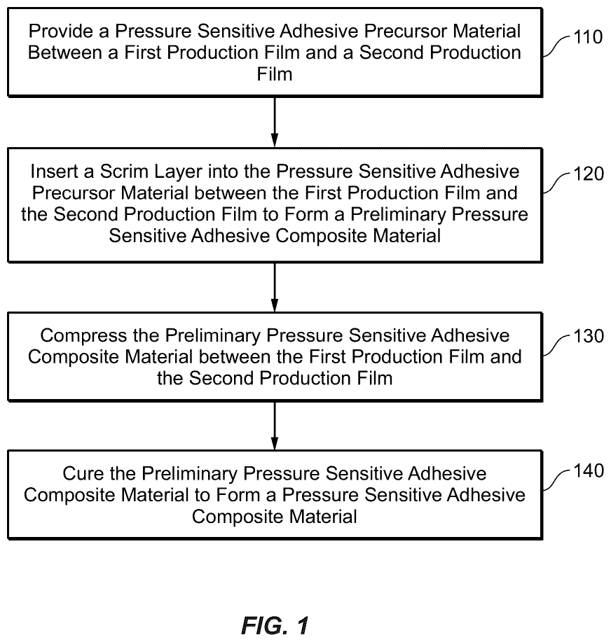

For purposes of illustration, FIG. 1 includes a diagram showing a pressure sensitive adhesive composite material forming method 100 according to particular embodiments described herein. The pressure sensitive adhesive composite material forming method 100 may include a first step 110 of providing a pressure sensitive adhesive precursor material between a first production film and a second production film, a second step 120 of inserting a scrim layer into the pressure sensitive adhesive precursor material between the first production film and the second production film to form a preliminary pressure sensitive adhesive composite material between the first production film and the second production film, a third step 130 of compressing the preliminary pressure sensitive adhesive composite material between the first production film and the second production film, and a fourth step 140 of curing the compressed preliminary pressure sensitive adhesive composite material to form the pressure sensitive adhesive composite material.

Referring to the first step 110, according to certain embodiments, the pressure sensitive adhesive precursor material may include a particular material. For example, the pressure sensitive adhesive precursor material may include an uncured acrylic-adhesive material. According to still other embodiments, the pressure sensitive adhesive precursor material may consist of an uncured acrylic-adhesive material. According to still other embodiments, the pressure sensitive adhesive precursor material may be an uncured pressure sensitive acrylic-adhesive material.

According to yet other embodiments, the scrim layer may include a particular material. According to yet other embodiments, the scrim layer may include a polymer material. According to still other embodiments, the scrim layer may consist of a polymer material. According to still other embodiments, the scrim layer may include polymer fibers. According to yet other embodiments, the scrim layer may include a glass material. According to still other embodiments, the scrim layer may consist of a glass material. According to still other embodiments, the scrim layer may include glass fibers. According to yet other embodiments, the scrim layer may include any combination of a polymer material and a glass material. According to still other embodiments, the scrim layer may consist of any combination of a polymer material and a glass material. According to still other embodiments, the scrim layer may include any combination of a polymer fibers and glass fibers.

According to certain embodiments, the scrim layer may have a particular window size as measured according to digital caliper measurement (DAkkS calibrated). For example, the scrim layer may have a window size of at least about 5 mm², such as, at least about 7 mm² or at least about 10 mm² or at least about 12 mm² or at least about 15 mm² or at least about 17 mm² or at least about 20 mm² or even at least about 22 mm². According to still other embodiments, the scrim layer may have a window size of not greater than about 40 mm², such as, not greater than about 37 mm² or not greater than about 35 mm² or not greater than about 32 mm² or not greater than about 30 mm² or not greater than about 27 mm² or even not greater than about 25 mm². It will be appreciated that the scrim layer may have a window size within a range between any of the minimum and maximum values noted above. It will be further appreciated that the scrim layer may have a window size of any value between any of the minimum and maximum values noted above.

Referring now to a pressure sensitive adhesive composite material, embodiments described herein may further be generally directed to a pressure sensitive adhesive composite material that may include a pressure sensitive adhesive layer that may include a pressure sensitive adhesive material, and a scrim layer that may include a grid of fibers. According to certain embodiments, the scrim layer may be encased within the pressure sensitive adhesive layer. According to still other embodiments, the pressure sensitive adhesive composite material may include a grid region of the fibers coated with the pressure sensitive adhesive material, and a plurality of window regions of the pressure sensitive adhesive material between the fibers.

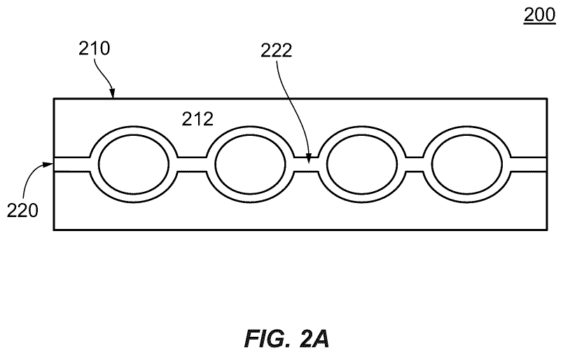

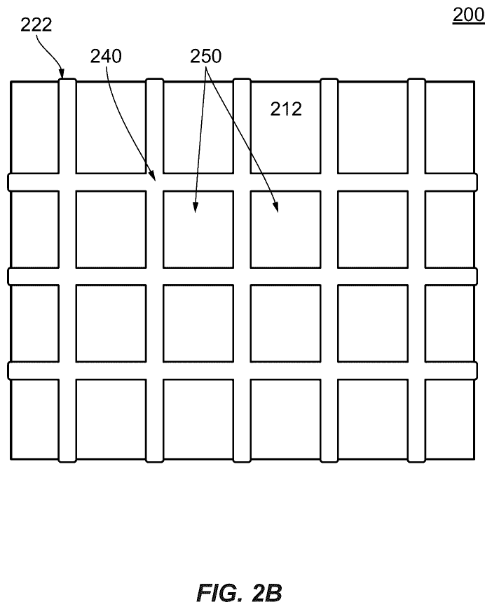

For purposes of illustration, FIG. 2a includes an illustration showing a side view of a configuration of a pressure sensitive adhesive composite material 200 formed according to embodiments described herein. As shown in FIG. 2a, the pressure sensitive adhesive composite material 200 may include a pressure sensitive adhesive layer 210, and scrim layer 220. According to certain embodiments, the adhesive layer 210 may include a pressure sensitive adhesive material 212. According to still other embodiments, the scrim layer 220 may include a grid of fibers 222. According to certain embodiments and as shown in FIG. 2, the scrim layer 220 may be encased within the adhesive layer 210.

For purposes of further illustration, FIG. 2b includes an illustration showing a top view of a configuration of a pressure sensitive adhesive composite material 200 formed according to embodiments described herein. As shown in FIG. 2b and according to certain embodiments, the pressure sensitive adhesive composite material 200 may include a grid region 240 of the fibers 222 coated with the pressure sensitive pressure sensitive adhesive material 212. As further shown in in FIG. 2b and according to certain embodiments, pressure sensitive adhesive composite material 200 may further include a plurality of widow regions 250 of the pressure sensitive adhesive material 212 between the fibers 222.

According to certain embodiments, the pressure sensitive adhesive material 212 may include a particular material. For example, the pressure sensitive adhesive material 212 may include an acrylic-adhesive material. According to still other embodiments, the pressure sensitive adhesive material 212 may consist of an acrylic-adhesive material. According to still other embodiments, the pressure sensitive adhesive material 212 may be a pressure sensitive acrylic-adhesive material.

According to certain embodiments, the pressure sensitive adhesive layer 210 may include a particular material. For example, the pressure sensitive adhesive layer 210 may include an acrylic-adhesive material. According to still other embodiments, the pressure sensitive adhesive layer 210 may consist of an acrylic-adhesive material. According to still other embodiments, the pressure sensitive adhesive layer 210 may be a pressure sensitive acrylic-adhesive material.

According to yet other embodiments, the grid of fibers 222 may include a particular material. According to yet other embodiments, the grid of fibers 222 may include a polymer material. According to still other embodiments, the grid of fibers 222 may consist of a polymer material. According to still other embodiments, the grid of fibers 222 may include polymer fibers. According to yet other embodiments, the grid of fibers 222 may include a glass material. According to still other embodiments, the grid of fibers 222 may consist of a glass material. According to still other embodiments, the grid of fibers 222 may include glass fibers. According to yet other embodiments, the grid of fibers 222 may include any combination of a polymer material and a glass material. According to still other embodiments, the grid of fibers 222 may consist of any combination of a polymer material and a glass material. According to still other embodiments, the grid of fibers 222 may include any combination of a polymer fibers and glass fibers.

According to yet other embodiments, the scrim layer 220 may include a particular material. According to yet other embodiments, the scrim layer 220 may include a polymer material. According to still other embodiments, the scrim layer 220 may consist of a polymer material. According to still other embodiments, the scrim layer 220 may include polymer fibers. According to yet other embodiments, the scrim layer 220 may include a glass material. According to still other embodiments, the scrim layer 220 may consist of a glass material. According to still other embodiments, the scrim layer 220 may include glass fibers. According to yet other embodiments, the scrim layer 220 may include any combination of a polymer material and a glass material. According to still other embodiments, the scrim layer 220 may consist of any combination of a polymer material and a glass material. According to still other embodiments, the scrim layer 220 may include any combination of a polymer fibers and glass fibers.

According to certain embodiments, the scrim layer 220 may have a particular window size as measured according to digital caliper measurement (DAkkS calibrated). For example, the scrim layer 220 may have a window size of at least about 5 mm², such as, at least about 7 mm² or at least about 10 mm² or at least about 12 mm² or at least about 15 mm² or at least about 17 mm² or at least about 20 mm² or even at least about 22 mm². According to still other embodiments, the scrim layer 220 may have a window size of not greater than about 40 mm², such as, not greater than about 37 mm² or not greater than about 35 mm² or not greater than about 32 mm² or not greater than about 30 mm² or not greater than about 27 mm² or even not greater than about 25 mm². It will be appreciated that the scrim layer 220 may have a window size within a range between any of the minimum and maximum values noted above. It will be further appreciated that the scrim layer 220 may have a window size of any value between any of the minimum and maximum values noted above.

According to particular embodiments, the pressure sensitive adhesive composite 200 may have a variable thickness where an average thickness of the plurality of widow regions 250 is less than an average thickness of the pressure sensitive adhesive composite material 200. It will be appreciated for embodiments described herein, the average thickness of the pressure sensitive adhesive composite material 200 is measured according to DIN EN ISO 534. It will be further appreciated that for embodiments described herein, the average thickness of the plurality of widow regions 250 is measured according to topographic or cross-sectional analysis measurement.

According to yet other embodiments, the pressure sensitive adhesive composite 200 may have a particular thickness ratio WR_{T}/GR_{T}, where WR_{T} is equal to an average thickness of the plurality of widow regions 250 as measured according to topographic or cross-sectional analysis measurement and GR_{T} is equal to an average thickness of the pressure sensitive adhesive composite material 200 as measured according to topographic or cross-sectional analysis measurement. For example, the pressure sensitive adhesive composite 200 may have a thickness ratio WR_{T}/GR_{T} of not greater than about 1.0, such as, not greater than about 0.99 or not greater than about 0.98 or not greater than about 0.97 or even not greater than about 0.96. According to still other embodiments, the pressure sensitive adhesive composite 200 may have a thickness ratio WR_{T}/GR_{T} of at least about 0.90 or at least about 0.91 or at least about 0.92 or at least about 0.93 or even at least about 0.94. It will be appreciated that the pressure sensitive adhesive composite 200 may have a thickness ratio WR_{T}/GR_{T} within a range between any of the minimum and maximum values noted above. It will be further appreciated that the pressure sensitive adhesive composite 200 may have a thickness ratio WR_{T}/GR_{T} of any value between any of the minimum and maximum values noted above.

According to still other embodiments, the plurality of widow regions 250 may have a particular average thickness as measured according to DIN EN ISO 534. For example, the plurality of widow regions 250 may have an average thickness of at least about 5 microns, such as, at least about 10 microns or at least about 15 microns or at least about 20 microns or at least about 25 microns or at least about 30 microns or at least about 35 microns or even at least about 40 microns. According to yet other embodiments, the plurality of widow regions 250 may have an average thickness of not greater than about 80 microns, such as, not greater than about 240 microns or not greater than about 75 microns or not greater than about 70 microns or not greater than about 65 microns or not greater than about 60 microns or not greater than about 55 microns or not greater than about 50 microns or even not greater than about 45 microns. It will be appreciated that the plurality of widow regions 250 may have an average thickness within a range between any of the minimum and maximum values noted above. It will be further appreciated that the plurality of widow regions 250 may have an average thickness of any value between any of the minimum and maximum values noted above.

According to still other embodiments, the pressure sensitive adhesive composite material 200 may have a particular average thickness as measured according to DIN EN ISO 534. For example, the pressure sensitive adhesive composite material 200 may have an average thickness of at least about 70 microns, such as, at least about 80 microns or at least about 90 microns or at least about 100 microns or at least about 110 microns or even at least about 120 microns. According to yet other embodiments, the pressure sensitive adhesive composite material 200 may have an average thickness of not greater than about 250 microns, such as, not greater than about 240 microns or not greater than about 230 microns or not greater than about 220 microns or not greater than about 210 microns or not greater than about 200 microns or not greater than about 190 microns or not greater than about 180 microns or even not greater than about 170 microns. It will be appreciated that the pressure sensitive adhesive composite material 200 may have an average thickness within a range between any of the minimum and maximum values noted above. It will be further appreciated that the pressure sensitive adhesive composite material 200 may have an average thickness of any value between any of the minimum and maximum values noted above.

According to still other embodiments, the pressure sensitive adhesive composite material 200 may have a particular average thickness as measured according to DIN EN ISO 534. For example, the pressure sensitive adhesive composite material 200 may have an average thickness of at least about 70 microns, such as, at least about 80 microns or at least about 90 microns or at least about 100 microns or at least about 110 microns or even at least about 120 microns. According to yet other embodiments, the pressure sensitive adhesive composite material 200 may have an average thickness of not greater than about 250 microns, such as, not greater than about 240 microns or not greater than about 230 microns or not greater than about 220 microns or not greater than about 210 microns or not greater than about 200 microns or not greater than about 190 microns or not greater than about 180 microns or even not greater than about 170 microns. It will be appreciated that the pressure sensitive adhesive composite material 200 may have an average thickness within a range between any of the minimum and maximum values noted above. It will be further appreciated that the pressure sensitive adhesive composite material 200 may have an average thickness of any value between any of the minimum and maximum values noted above.

According to still other embodiments, the pressure sensitive adhesive composite material 200 may have a particular average weight as measured according to weight measurement ISO 536. For example, the pressure sensitive adhesive composite material 200 may have an average weight of at least about 10 g/m², such as, at least about 20 g/m² or at least about 30 g/m² or at least about 40 g/m² or at least about 50 g/m² or at least about 60 g/m² or at least about 70 g/m² or at least about 80 g/m² or at least about 90 g/m² or even at least about 100 g/m². According to yet other embodiments, the pressure sensitive adhesive composite material 200 may have an average weight of not greater than about 200 g/m², such as, not greater than about 190 g/m² or not greater than about 180 g/m² or not greater than about 170 g/m² or not greater than about 160 g/m² or not greater than about 150 g/m² or not greater than about 140 g/m² or not greater than about 130 g/m² or even not greater than about 120 g/m². It will be appreciated that the pressure sensitive adhesive composite material 200 may have an average weight within a range between any of the minimum and maximum values noted above. It will be further appreciated that the pressure sensitive adhesive composite material 200 may have an average weight of any value between any of the minimum and maximum values noted above.

According to still other embodiments, the pressure sensitive adhesive composite material 200 may have particular adhesion strength as measured according to AFERA 5001. For example, the pressure sensitive adhesive composite material 200 may have an adhesion strength of at least about 5 N/25 mm, such as, at least about 10 N/25 mm or at least about 15 N/25 mm or at least about 20 N/25 mm or at least about 25 N/25 mm or at least about 30 N/25 mm or even at least about 35 N/25 mm. According to yet other embodiments, the pressure sensitive adhesive composite material 200 may have an adhesion strength of not greater than about 75 N/25 mm, such as, not greater than about 70 N/25 mm or not greater than about 65 N/25 mm or not greater than about 60 N/25 mm or not greater than about 55 N/25 mm or not greater than about 50 N/25 mm or not greater than about 45 N/25 mm or even not greater than about 40 N/25 mm. It will be appreciated that the pressure sensitive adhesive composite material 200 may have an adhesion strength within a range between any of the minimum and maximum values noted above. It will be further appreciated that the pressure sensitive adhesive composite material 200 may have an adhesion strength of any value between any of the minimum and maximum values noted above.

According to still other embodiments, the pressure sensitive adhesive composite material 200 may have a particular moisture vapor transmission rate (MVTR) as measured according to ASTM E96 or DIN EN ISO 12572. For example, the pressure sensitive adhesive composite material 200 may have an MVTR of at least about 40 g/m²/24 h, such as, at least about 100 g/m²/24 h or at least about 200 g/m²/24 h or at least about 300 g/m²/24 h or at least about 400 g/m²/24 h or at least about 500 g/m²/24 h or even at least about 600 g/m²/24 h. According to yet other embodiments, the pressure sensitive adhesive composite material 200 may have an MVTR of not greater than about 2000 g/m²/24 h, such as, not greater than about 1800 g/m²/24 h or not greater than about 1600 g/m²/24 h or not greater than about 1400 g/m²/24 h or not greater than about 1200 g/m²/24 h or even not greater than about 1000 g/m²/24 h. It will be appreciated that the pressure sensitive adhesive composite material 200 may have an MVTR within a range between any of the minimum and maximum values noted above. It will be further appreciated that the pressure sensitive adhesive composite material 200 may have an MVTR of any value between any of the minimum and maximum values noted above.

According to still other embodiments, the pressure sensitive adhesive composite material 200 may have a particular apparent density as calculated from the grid region thickness and the composite weigh of the material in g/m². For example, the pressure sensitive adhesive composite material 200 may have an apparent density of at least about 0.25 g/cm³, such as, at least about 0.30 g/cm³ or at least about 0.35 g/cm³ or at least about 0.40 g/cm³ or at least about 0.45 g/cm³ or even at least about 0.50 g/cm³. According to yet other embodiments, the pressure sensitive adhesive composite material 200 may have an apparent density of not greater than about 1.0 g/cm³, such as, not greater than about 0.95 g/cm³ or not greater than about 0.90 g/cm³ or not greater than about 0.85 g/cm³ or not greater than about 0.80 g/cm³ or not greater than about 0.75 g/cm³ or not greater than about 0.70 g/cm³ or even not greater than about 0.65 g/cm³. It will be appreciated that the pressure sensitive adhesive composite material 200 may have an apparent density within a range between any of the minimum and maximum values noted above. It will be further appreciated that the pressure sensitive adhesive composite material 200 may have an apparent density of any value between any of the minimum and maximum values noted above.

According to still other embodiments, the pressure sensitive adhesive composite material 200 may have a particular Sd value as measured according to dry cup permeability measurement over 24 h (based on DIN EN ISO 12572). For example, the pressure sensitive adhesive composite material 200 may have an Sd value of at least about 0.25 meters, such as, at least about 0.005 meters or at least about 0.01 meters or at least about 0.02 meters or at least about 0.03 meters or at least about 0.04 meters or at least about 0.05 meters or at least about 0.06 meters or at least about 0.07 meters or at least about 0.08 meters or at least about 0.09 meters or even at least about 0.10 meters. According to yet other embodiments, the pressure sensitive adhesive composite material 200 may have an Sd value of not greater than about 0.25 meters, such as, not greater than about 0.24 meters or not greater than about 0.23 meters or not greater than about 0.22 meters or not greater than about 0.21 meters or not greater than about 0.20 meters or not greater than about 0.19 meters or even not greater than about 0.18 meters. It will be appreciated that the pressure sensitive adhesive composite material 200 may have an Sd value within a range between any of the minimum and maximum values noted above. It will be further appreciated that the pressure sensitive adhesive composite material 200 may have an Sd value of any value between any of the minimum and maximum values noted above.

According to still other embodiments, the pressure sensitive adhesive composite material 200 may have a particular surface roughness as measured according to ISO 4287 using topographic or cross-sectional analysis measurement over an area of the material encompassing at least 3 separate window regions. For example, the pressure sensitive adhesive composite material 200 may have a surface roughness of at least about 5 microns, such as, at least about 10 microns or at least about 20 microns or at least about 30 microns or at least about 40 microns or at least about 50 microns or at least about 60 microns or at least about 70 microns or at least about 80 microns or at least about 90 microns or at least about 100 microns or at least about 110 microns or even at least about 120 microns. According to yet other embodiments, the pressure sensitive adhesive composite material 200 may have a surface roughness of not greater than about 250 microns, such as, not greater than about 240 microns or not greater than about 230 microns or not greater than about 220 microns or not greater than about 210 microns or not greater than about 200 microns or not greater than about 190 microns or not greater than about 180 microns or even not greater than about 170 microns. It will be appreciated that the pressure sensitive adhesive composite material 200 may have a surface roughness within a range between any of the minimum and maximum values noted above. It will be further appreciated that the pressure sensitive adhesive composite material 200 may have a surface roughness of any value between any of the minimum and maximum values noted above.

According to still other embodiments, the pressure sensitive adhesive composite material formed according to embodiments described herein may be applied as an adhesive layer on a backing or liner to form a tape.

According to more particular embodiments, the backing or liner of the tape may be a polyester film. According to still other embodiments, the backing or liner of the tape may be a polyolefin film. According to yet other embodiments, the backing or liner of the tape may be a paper film.

According to more particular embodiments, the backing or liner of the tape may include any material selected from the group of polytetrafluoroethylene, polyethylene terephthalate, polyethylene, polypropylene, polyvinyl chloride, polyimide, polyethylene naphthalate, polyphenylene Sulfide, ethylene tetrafluoroethylene, fluorinated ethylene propylene, aluminum foil, glass (fabric), paper, polyamide, cellulose, or combinations thereof.

According to still other embodiments, the backing or liner may have a particular thickness as measured according to DIN EN ISO 534. For example, the backing or liner may have a thickness of at least about 25 microns, such as, at least about 30 microns or at least about 35 microns or at least about 40 microns or at least about 45 microns or at least about 50 microns or at least about 60 microns or at least about 70 microns or at least about 80 microns or at least about 90 microns or at least about 100 microns or at least about 110 microns or even at least about 120 microns. According to yet other embodiments, the backing or liner may have a thickness of not greater than about 250 microns, such as, not greater than about 240 microns or not greater than about 230 microns or not greater than about 220 microns or not greater than about 210 microns or not greater than about 200 microns or not greater than about 190 microns or not greater than about 180 microns or even not greater than about 170 microns. It will be appreciated that the backing or liner may have a thickness within a range between any of the minimum and maximum values noted above. It will be further appreciated that the backing or liner may have a thickness of any value between any of the minimum and maximum values noted above.

According to still other embodiments, the tape may have a particular thickness as measured according to DIN EN ISO 534. For example, the tape may have a thickness of at least about 20 microns, such as, at least about 30 microns or at least about 35 microns or at least about 40 microns or at least about 45 microns or at least about 50 microns or at least about 60 microns or at least about 70 microns or at least about 80 microns or at least about 90 microns or at least about 100 microns or at least about 110 microns or even at least about 120 microns. According to yet other embodiments, the tape may have a thickness of not greater than about 500 microns, such as, not greater than about 475 microns or not greater than about 450 microns or not greater than about 425 microns or not greater than about 400 microns or not greater than about 375 microns or not greater than about 350 microns or not greater than about 325 microns or even not greater than about 300 microns. It will be appreciated that the tape may have a thickness within a range between any of the minimum and maximum values noted above. It will be further appreciated that the tape may have a thickness of any value between any of the minimum and maximum values noted above.

According to still other embodiments, the tape may have a particular adhesion strength as measured according to AFERA 5001. For example, the tape may have an adhesion strength of at least about 5 N/25 mm, such as, at least about 10 N/25 mm or at least about 15 N/25 mm or at least about 20 N/25 mm or at least about 25 N/25 mm or at least about 30 N/25 mm or even at least about 35 N/25 mm. According to yet other embodiments, the tape may have an adhesion strength of not greater than about 75 N/25 mm, such as, not greater than about 70 N/25 mm or not greater than about 65 N/25 mm or not greater than about 60 N/25 mm or not greater than about 55 N/25 mm or not greater than about 50 N/25 mm or not greater than about 45 N/25 mm or even not greater than about 40 N/25 mm. It will be appreciated that the tape may have an adhesion strength within a range between any of the minimum and maximum values noted above. It will be further appreciated that the tape may have an adhesion strength of any value between any of the minimum and maximum values noted above.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A pressure sensitive adhesive composite material comprising: a pressure sensitive adhesive layer comprising a pressure sensitive adhesive material, and a scrim layer comprising a grid of fibers, wherein the scrim layer is encased within the pressure sensitive adhesive layer, wherein the pressure sensitive adhesive composite material comprises a grid region of the fibers coated with the pressure sensitive adhesive material, and a plurality of window regions of the pressure sensitive adhesive material between the fibers, and wherein an average thickness of the plurality of widow regions is less than an average thickness of the grid region.

Embodiment 2. A pressure sensitive adhesive composite material comprising: a pressure sensitive adhesive layer comprising a pressure sensitive adhesive material, and a scrim layer comprising a grid of fibers, wherein the scrim layer is encased within the pressure sensitive adhesive layer, wherein the pressure sensitive adhesive composite material comprises a grid region of the fibers coated with the pressure sensitive adhesive material, and a plurality of window regions of the pressure sensitive adhesive material between the fibers, and wherein the pressure sensitive adhesive composite material comprises a surface roughness of at least about 5 microns.

Embodiment 3. A pressure sensitive adhesive composite material comprising: a pressure sensitive adhesive layer comprising a pressure sensitive adhesive material, and a scrim layer comprising a grid of fibers, wherein the scrim layer is encased within the pressure sensitive adhesive layer, wherein the pressure sensitive adhesive composite material comprises a grid region of the fibers coated with the pressure sensitive adhesive material, and a plurality of window regions of the pressure sensitive adhesive material between the fibers, and wherein the pressure sensitive adhesive composite material comprises an apparent density of not greater than about 1 g/cm³.

Embodiment 4. The pressure sensitive adhesive composite of any one of the previous embodiments, wherein an average thickness of the plurality of widow regions is less than an average thickness of the grid region.

Embodiment 5. The pressure sensitive adhesive composite of any one of the previous embodiments, wherein the composite material comprises a thickness ratio WR_{T}/GR_{T} of not greater than about 1.0, where WR_{T} is equal to an average thickness of the plurality of widow regions, and GR_{T} is equal to an average thickness of the grid region.

Embodiment 6. The pressure sensitive adhesive composite of any one of the previous embodiments, wherein the composite material comprises a thickness ratio WR_{T}/GR_{T} of at least about 0.9, where WR_{T} is equal to an average thickness of the plurality of widow regions, and GR_{T} is equal to an average thickness of the grid region.

Embodiment 7. The pressure sensitive adhesive composite of any one of the previous embodiments, wherein the pressure sensitive adhesive composite material comprises a surface roughness of at least about 5 microns.

Embodiment 8. The pressure sensitive adhesive composite of any one of the previous embodiments, wherein the pressure sensitive adhesive composite material comprises a surface roughness of not greater than about 250 microns.

Embodiment 9. The pressure sensitive adhesive composite of any one of the previous embodiments, wherein the pressure sensitive adhesive composite material comprises an apparent density of not greater than about 1 g/cm³.

Embodiment 10. The pressure sensitive adhesive composite of any one of the previous embodiments, wherein the pressure sensitive adhesive composite material comprises an apparent density of at least about 0.25 g/cm³.

Embodiment 11. The pressure sensitive adhesive composite of any one of the previous embodiments, wherein the pressure sensitive adhesive composite material comprises an Sd value of at least about 0.005 m.

Embodiment 12. The pressure sensitive adhesive composite of any one of the previous embodiments, wherein the pressure sensitive adhesive composite material comprises an Sd value of not greater than about 0.25 m.

Embodiment 13. The pressure sensitive adhesive composite of any one of the previous embodiments, wherein the pressure sensitive adhesive composite material comprises an MVTR of at least about 40 g/m²/24 h.

Embodiment 14. The pressure sensitive adhesive composite of any one of the previous embodiments, wherein the pressure sensitive adhesive composite material comprises an MVTR of not greater than about 2000 g/m²/24 h.

Embodiment 15. The pressure sensitive adhesive composite of any one of the previous embodiments, wherein the pressure sensitive adhesive composite material comprises adhesion strength of at least about 5 N/25 mm.

Embodiment 16. The pressure sensitive adhesive composite of any one of the previous embodiments, wherein the pressure sensitive adhesive composite material comprises an adhesion strength of not greater than about 75 N/25 mm.

Embodiment 17. The pressure sensitive adhesive composite of any one of the previous embodiments, wherein the pressure sensitive adhesive composite material comprises an average weight of at least about 10 g/m².

Embodiment 18. The pressure sensitive adhesive composite of any one of the previous embodiments, wherein the pressure sensitive adhesive composite material comprises an average weight of not greater than about 200 g/m².

Embodiment 19. The pressure sensitive adhesive composite of any one of the previous embodiments, wherein the pressure sensitive adhesive composite material comprises an average thickness of at least about 70 microns.

Embodiment 20. The pressure sensitive adhesive composite of any one of the previous embodiments, wherein the pressure sensitive adhesive composite material comprises an average thickness of not greater than about 250 microns.

Embodiment 21. The pressure sensitive adhesive composite of any one of the previous embodiments, wherein the plurality of window regions comprise an average thickness of not greater than about 80 microns.

Embodiment 22. The pressure sensitive adhesive composite of any one of the previous embodiments, wherein the plurality of window regions comprise an average thickness of at least about 5 microns.

Embodiment 23. The pressure sensitive adhesive composite of any one of the previous embodiments, wherein the grid region comprises an average thickness of not greater than about 250 microns.

Embodiment 24. The pressure sensitive adhesive composite of any one of the previous embodiments, wherein the grid region comprises an average thickness of at least about 70 microns.

Embodiment 25. The pressure sensitive adhesive composite of any one of the previous embodiments, wherein the scrim layer comprises a window size of at least about 5 mm².

Embodiment 26. The pressure sensitive adhesive composite of any one of the previous embodiments, wherein the scrim layer comprises a window size of not greater than about 40 mm².

Embodiment 27. The pressure sensitive adhesive composite of any one of the previous embodiments, wherein the scrim layer comprises a polymer scrim layer, a glass scrim layer, or any combination thereof.

Embodiment 28. The pressure sensitive adhesive composite of any one of the previous embodiments, fibers of the scrim layer comprise a polymer scrim layer, a glass scrim layer, or any combination thereof.

Embodiment 29. The pressure sensitive adhesive composite of any one of the previous embodiments, wherein the pressure sensitive adhesive material comprises an acrylic-adhesive material.

Embodiment 30. A tape comprising a backing liner material, and a pressure sensitive adhesive composite material of any one of the previous embodiments, wherein the pressure sensitive adhesive composite material overlies a surface of the backing liner material.

Embodiment 31. The tape of embodiment 30, wherein the backing liner material comprises a polyester film, a polyolefin film, or a paper film.

Embodiment 32. The tape of embodiment 30, wherein the backing liner material has a thickness of at least about 25 microns.

Embodiment 33. The tape of embodiment 30, wherein the backing liner material has a thickness of not greater than about 250 microns.

Embodiment 34. The tape of embodiment 30, wherein the tape has a thickness of at least about 20 microns.

Embodiment 35. The tape of embodiment 30, wherein the tape has a thickness of not greater than about 500 microns.

Embodiment 36. The tape of embodiment 30, wherein the tape comprises an adhesion strength of at least about 5 N/25 mm.

Embodiment 37. The tape of embodiment 30, wherein the tape comprises an adhesion strength of not greater than about 75 N/25 mm.

Embodiment 38. A method of forming a pressure sensitive adhesive composite material, wherein the method comprises: providing a pressure sensitive adhesive precursor material between a first production film and a second production film, inserting a scrim layer into the pressure sensitive adhesive precursor material between the first production film and the second production film to form a preliminary pressure sensitive adhesive composite material between the first production film and the second production film, compressing the preliminary pressure sensitive adhesive composite material between the first production film and the second production film, and curing the preliminary pressure sensitive adhesive composite material to form the pressure sensitive adhesive composite material, wherein the pressure sensitive adhesive composite material comprises: a pressure sensitive adhesive layer comprising the pressure sensitive adhesive material, and a scrim layer comprising a grid of fibers, wherein the scrim layer is encased within the pressure sensitive adhesive layer.

Embodiment 39. The method of embodiment 38, wherein the method further comprises removing the first production film and the second production film from the preliminary pressure sensitive adhesive composite material.

Embodiment 40. The method of embodiment 38, wherein compressing the preliminary pressure sensitive adhesive composite material between the first production film and the second production film to form the pressure sensitive adhesive composite material further comprising moving the first production film and the second production film between two rollers.

Embodiment 41. The method of embodiment 38, wherein the pressure sensitive adhesive composite material comprises a grid region of the fibers coated with the pressure sensitive adhesive material, and a plurality of window regions of the pressure sensitive adhesive material between the fibers.

Embodiment 42. The method of embodiment 41, wherein an average thickness of the plurality of widow regions is less than an average thickness of the grid region.

Embodiment 43. The method of embodiment 42, wherein the composite material comprises a thickness ratio WR_{T}/GR_{T} of not greater than about 1, where WR_{T} is equal to an average thickness of the plurality of widow regions, and GR_{T} is equal to an average thickness of the grid region.

Embodiment 44. The method of embodiment 42, wherein the composite material comprises a thickness ratio WR_{T}/GR_{T} of at least about 0.9, where WR_{T} is equal to an average thickness of the plurality of widow regions, and GR_{T} is equal to an average thickness of the grid region.

Embodiment 45. The method of embodiment 42, wherein the pressure sensitive adhesive composite material comprises a surface roughness of at least about 5 microns.

Embodiment 46. The method of embodiment 42, wherein the pressure sensitive adhesive composite material comprises a surface roughness of not greater than about 250 microns.

Embodiment 47. The method of embodiment 42, wherein the pressure sensitive adhesive composite material comprises an apparent density of not greater than about 1 g/cm³.

Embodiment 48. The method of embodiment 42, wherein the pressure sensitive adhesive composite material comprises an apparent density of at least about 0.25 g/cm³.

Embodiment 49. The method of embodiment 42, wherein the pressure sensitive adhesive composite material comprises an Sd value of at least about 0.005 m.

Embodiment 50. The method of embodiment 42, wherein the pressure sensitive adhesive composite material comprises an Sd value of not greater than about 0.25 m.

Embodiment 51. The method of embodiment 42, wherein the pressure sensitive adhesive composite material comprises an MVTR of at least about 40 g/m²/24 h.

Embodiment 52. The method of embodiment 42, wherein the pressure sensitive adhesive composite material comprises an MVTR of not greater than about 2000 g/m²/24 h.

Embodiment 53. The method of embodiment 42, wherein the pressure sensitive adhesive composite material comprises an adhesion strength of at least about 5 N/25 mm.

Embodiment 54. The method of embodiment 42, wherein the pressure sensitive adhesive composite material comprises an adhesion strength of not greater than about 75 N/25 mm.

Embodiment 55. The method of embodiment 42, wherein the pressure sensitive adhesive composite material comprises an average weight of at least about 10 g/m².

Embodiment 56. The method of embodiment 42, wherein the pressure sensitive adhesive composite material comprises an average thickness of not greater than about 200 g/m².

Embodiment 57. The method of embodiment 42, wherein the pressure sensitive adhesive composite material comprises an average thickness of at least about 70 microns.

Embodiment 58. The method of embodiment 42, wherein the pressure sensitive adhesive composite material comprises an average thickness of not greater than about 250 microns.

Embodiment 59. The method of embodiment 42, wherein the plurality of window regions comprise an average thickness of not greater than about 80 microns.

Embodiment 60. The method of embodiment 42, wherein the plurality of window regions comprise an average thickness of at least about 5 microns.

Embodiment 61. The method of embodiment 42, wherein the grid region comprises an average thickness of not greater than about 250 microns.

Embodiment 62. The method of embodiment 42, wherein the grid region comprises an average thickness of at least about 70 microns.

Embodiment 63. The method of embodiment 42, wherein the scrim layer comprises a window size of at least about 5 mm².

Embodiment 64. The method of embodiment 42, wherein the scrim layer comprises a window size of not greater than about 40 mm².

Embodiment 65. The method of embodiment 42, wherein the scrim layer comprises a polymer scrim layer, a glass scrim layer, or any combination thereof.

Embodiment 66. The method of embodiment 42, fibers of the scrim layer comprise a polymer scrim layer, a glass scrim layer, or any combination thereof.

Embodiment 67. The method of embodiment 42, wherein the pressure sensitive adhesive material comprises an acrylic-adhesive.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. A pressure sensitive adhesive composite material comprising:
a pressure sensitive adhesive layer comprising a pressure sensitive adhesive material, and
a scrim layer comprising a grid of fibers,
wherein the scrim layer is encased within the pressure sensitive adhesive layer,
wherein the pressure sensitive adhesive composite material comprises a grid region of the fibers coated with the pressure sensitive adhesive material, and a plurality of window regions of the pressure sensitive adhesive material between the fibers, and
wherein an average thickness of the plurality of widow regions is less than an average thickness of the grid region.

2. The pressure sensitive adhesive composite of claim 1, wherein an average thickness of the plurality of widow regions is less than an average thickness of the grid region.

3. The pressure sensitive adhesive composite of claim 1, wherein the composite material comprises a thickness ratio WR_{T}/GR_{T} of not greater than about 1.0, where WR_{T} is equal to an average thickness of the plurality of widow regions, and GR_{T} is equal to an average thickness of the grid region.

4. The pressure sensitive adhesive composite of claim 1, wherein the composite material comprises a thickness ratio WR_{T}/GR_{T} of at least about 0.9, where WR_{T} is equal to an average thickness of the plurality of widow regions, and GR_{T} is equal to an average thickness of the grid region.

5. The pressure sensitive adhesive composite of claim 1, wherein the pressure sensitive adhesive composite material comprises a surface roughness of at least about 5 microns.

6. The pressure sensitive adhesive composite of claim 1, wherein the pressure sensitive adhesive composite material comprises a surface roughness of not greater than about 250 microns.

7. The pressure sensitive adhesive composite of claim 1, wherein the pressure sensitive adhesive composite material comprises an apparent density of not greater than about 1 g/cm³.

8. The pressure sensitive adhesive composite of claim 1, wherein the pressure sensitive adhesive composite material comprises an apparent density of at least about 0.25 g/cm³.

9. The pressure sensitive adhesive composite of claim 1, wherein the pressure sensitive adhesive composite material comprises an Sd value of at least about 0.005 m.

10. The pressure sensitive adhesive composite of claim 1, wherein the pressure sensitive adhesive composite material comprises an Sd value of not greater than about 0.25 m.

11. The pressure sensitive adhesive composite of claim 1, wherein the pressure sensitive adhesive composite material comprises an MVTR of at least about 40 g/m²/24 h.

12. The pressure sensitive adhesive composite of claim 1, wherein the pressure sensitive adhesive composite material comprises an MVTR of not greater than about 2000 g/m²/24 h.

13. The pressure sensitive adhesive composite of claim 1, wherein the pressure sensitive adhesive composite material comprises adhesion strength of at least about 5 N/25 mm.

14. A pressure sensitive adhesive composite material comprising:
a pressure sensitive adhesive layer comprising a pressure sensitive adhesive material, and
a scrim layer comprising a grid of fibers,
wherein the scrim layer is encased within the pressure sensitive adhesive layer,
wherein the pressure sensitive adhesive composite material comprises a grid region of the fibers coated with the pressure sensitive adhesive material, and a plurality of window regions of the pressure sensitive adhesive material between the fibers, and
wherein the pressure sensitive adhesive composite material comprises a surface roughness of at least about 5 microns.

15. The pressure sensitive adhesive composite of claim 14, wherein an average thickness of the plurality of widow regions is less than an average thickness of the grid region.

16. The pressure sensitive adhesive composite of claim 14, wherein the composite material comprises a thickness ratio WR_{T}/GR_{T} of not greater than about 1.0, where WR_{T} is equal to an average thickness of the plurality of widow regions, and GR_{T} is equal to an average thickness of the grid region.

17. The pressure sensitive adhesive composite of claim 14, wherein the composite material comprises a thickness ratio WR_{T}/GR_{T} of at least about 0.9, where WR_{T} is equal to an average thickness of the plurality of widow regions, and GR_{T} is equal to an average thickness of the grid region.

18. The pressure sensitive adhesive composite of claim 14, wherein the pressure sensitive adhesive composite material comprises a surface roughness of at least about 5 microns.

19. The pressure sensitive adhesive composite of claim 14, wherein the pressure sensitive adhesive composite material comprises a surface roughness of not greater than about 250 microns.

20. A pressure sensitive adhesive composite material comprising:
a pressure sensitive adhesive layer comprising a pressure sensitive adhesive material, and
a scrim layer comprising a grid of fibers,
wherein the scrim layer is encased within the pressure sensitive adhesive layer,
wherein the pressure sensitive adhesive composite material comprises a grid region of the fibers coated with the pressure sensitive adhesive material, and a plurality of window regions of the pressure sensitive adhesive material between the fibers, and
wherein the pressure sensitive adhesive composite material comprises an apparent density of not greater than about 1 g/cm³.
